(19) United States
(12) Patent Application Publication
(10) Pub. No.: US 2005/0222323 A1
(43) Pub. Date: Oct. 6, 2005

(54) Thermally conductive coating compositions, methods of production and uses thereof

(76) Inventors: Xiao-Qi Zhou, San Diego, CA (US); Paula M. Knoll, San Diego, CA (US)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/511,454

(22) PCT Filed: Apr. 10, 2003
(86) PCT No.: PCT/US03/11153

§ 371 Date: Oct. 12, 2004

Related U.S. Application Data
(60) Provisional application No. 60/372,525, filed on Apr. 11, 2002.

(51) Int. Cl. C08L 83/00

(52) U.S. Cl. 524/588

(57) ABSTRACT

A thermal interface composition is described herein that includes: a) at least two siloxane-based compounds; b) at least one inorganic micro-filler material; and c) at least one thermally conductive filler material. Additionally, a method of forming a thermal interface material is disclosed herein that includes: a) providing at least two siloxane-based compounds; b) providing at least one inorganic micro-filler material; c) providing at least one thermally conductive filler material; and d) combining the at least two siloxane-based compounds, the at least one inorganic micro-filler material and the at least one thermally conductive filler material.

### FIELD OF THE INVENTION

The field of the invention is thermally conductive coating compositions and material in electronic components, semiconductor components and other related layered materials applications.

### BACKGROUND

Electronic components are used in ever increasing numbers of consumer and commercial electronic products. Examples of some of these consumer and commercial products are televisions, computers, cell phones, pagers, palm-type organizers, portable radios, car stereos, or remote controls. As the demand for these consumer and commercial electronics increases, there is also a demand for those same products to become smaller, more efficient, longer lasting and more portable for the different end-users, including subcontractors, contractors, consumers and businesses.

As a result of the smaller size and lighter weight demands in these products, the components that comprise the products must also become smaller. Examples of some of those components that need to be reduced in size or scaled down are printed circuit, integrated circuits or wiring boards, resistors, wiring, keyboards, touch pads, and chip packaging.

When electronic components are reduced in size or scaled down, any defects or extraneous materials present in the larger components are going to be exaggerated in the scaled down components and are also going to physically and/or electrically influence other coupled components.

In order to identify and correct defects and minimize the influence of defects and extraneous materials in electronic components, the components, the materials used and the manufacturing processes for making those components should be broken down and analyzed. Electronic components are composed, in some cases, of layers of materials, such, as metals, polymers, metal alloys, inorganic materials or organometallic materials. The layers of materials are often thin (on the order of less than a millimeter in thickness) and can be delicate. There may also be layers of materials that comprise contaminants or other adulterating materials that should be analyzed and if possible either eliminated or contained.

Integrated circuit (IC) chips, for example, are designed to yield higher “infant mortality” results if the chips are initially defective, substandard or unreliable. Herein, infant mortality implies failure rate climaxes at the early stage of their lifetime. A “burn-in” process normally screens out the chips with poor reliability, where power and a series of test signals are applied to the circuit mounted on a socket to excise the circuit at an elevated temperature. Since failure rate of IC chips increase exponentially with temperature, the burn-in process can detect the questionable devices in as short duration as several hours. In the burn-in test, the junction temperature of the chips is desired to exceed over the normal operational temperature to accelerate the failure. However, the temperature must be well controlled in the high-powered devices to avoid overheating, which may shorten the total use life of the chips. Temperature control is accomplished by equipping the burn-in socket with a thermal interface material (TIM) between the test chips and heat sink.

Some thermal interface materials, such as GELVET® manufactured by Honeywell Electronic Materials™, have a significant technical issue: contamination of the integrated circuit (IC) chips with material from the thermal interface material. GELVET® is a composite of short carbon fibers that are densely planted along the Z direction in a base material that penetrates into the fiber matrix but leaves the top surface of the fiber free of resin. (see U.S. patent application Ser. Nos. 09/103,415; 09/103,416 and 09/333,564, which are commonly owned and incorporated herein in their entirety). This composite structure inevitably produces small amounts of loose fibers on the top surface of the structure that could then be easily transferred to the chip surface under the strong mechanical actuation during the burn-in process.

Suitable base materials used in GELVET®-type of applications and other similar applications are those materials that are compliant and yet strong, while ideal base materials are those materials that are not only compliant and strong, but also can be produced with a high degree of purity. Silicone is one of the best available polymers identified as a base material because of its compliant property and strength. However, it is well known that a considerable amount of volatile, low molecular weight components are present inherently as a consequence of the equilibrium polymerization utilized in silicon manufacture. Typically, silicones with viscosity below 50 cSt are more than 10% volatile, while those with a viscosity greater than 50 cSt are 0.5-4% volatile. After curing, liquid silicone monomers convert into a solid or semi-solid rubbery state polymer and the cross-linked network can then reduce the migration of liquid friction. Though a certain amount of monomers and oligomers will unavoidably escape out of the bulk base under the harsh burn-in conditions, resulting in an oily organic stain on the surface of IC chips. The contamination not only cosmetically stains the chip surface but also degrades the chip's thermal performance after packaging. So-called “space-grade” silicone has the least amount of low molecular weight oligomers by repeatedly distillation of industrial grade and accordingly is very expensive.

Generally though, the use of polymers in electronic devices, such as computers, cell phones, televisions, appliances, and radios, has gained increasing popularity for several reasons, including that a) electronic devices have gotten smaller and more complex, b) individual components of these devices have gotten smaller and are multi-tasking, c) polymers are cheaper and easier to produce than traditional solder or interface materials, and d) polymers can be easily tailored to the particular need of the component in the device unlike traditional solder material. Therefore, polymers continue to be investigated as suitable base materials and thus suitable to replace, in whole or in part, silicone.

There are several issued patents that aim to solve similar problems by using thermal conductive coating compositions. U.S. Pat. No. 4,842,911 discloses a composite thermal interface, which consists of dual layers of a compliant silicone rubber carried on either side of a porous glass cloth. The layers are filled with thermally conductive fillers. One of the silicone layers is pre-vulcanized, with the other being cured and bonded in place once the interface applied.

U.S. Pat. Nos. 5,950,066 and 6,197,859 to Green and Misra teach a thermal conductive coating composition, which is coated on both sides of a metal foil to form a sandwiched compilable thermal interface between IC device and heat sink. The composition is made of an alkyl substituted poly(hydro, methyl-siloxane), a flexibilizer and thermally conductive filler. The composition is a wax-like material. U.S. Pat. No. 4,473,113 disclosed a thermally conductive sheet for the application to the surface of an electronic apparatus. The sheets is provided as having a coating on each side thereof a material which changes state from a solid to liquid within the operating temperature range of the electronic apparatus. The material may be formulated as a meltable mixture of wax and zinc oxide. These applications that comprise wax-like materials will likely produce similar defects as silicone.

U.S. Pat. No. 6,037,695 to Weixel teaches a composite thermal interface pad. The pad consists of a cavitied template made from the resilient material, filled with pliable thermal grease or thermal putty. U.S. Pat. No. 5,060,114 disclosed a conformable, gel-like pad filled with thermally conductive filers. A thin sheet of thermally conductive metal such as aluminum is positioned in contact with the surface of the conformable pad for increased thermal transfer.

U.S. Pat. Nos. 5,213,868 and 5,298,791 teach a thermally conductive interface composite cased on a laminated acrylic pressure sensitive adhesive tape. At least one surface of the tape is provided as having channels or through-holes formed for the removal of air from between surfaces of heat sink or devices.

U.S. Pat. No. 5,321,582 disclosed an electronic component heat sink assembly which includes a thermally conductive laminate formed of polyamide which underlies a boron nitride-filled silicone layer. The laminate is interposed between the electronic component and the housing of the assembly.

Despite advances made in the field of thermal interface materials and coating compositions, there is still a need in the electronic, semiconductor and layered materials industries to produce a thermal interface material and/or a coating composition that a) has a low thermal resistance; b) is relatively free of oil contamination; c) makes a good coating composition; and d) can make a self-assembled physical barrier or interface between the underlying thermal interface material and additional components.

### SUMMARY OF THE SUBJECT MATTER

A thermal interface composition is described herein that includes: a) at least two siloxane-based compounds; b) at least one inorganic micro-filler material; and c) at least one thermally conductive filler material.

Additionally, a method of forming a thermal interface material is disclosed herein that includes: a) providing at least two siloxane-based compounds; b) providing at least one inorganic micro-filler material; c) providing at least one thermally conductive filler material; and d) combining the at least two siloxane-based compounds, the at least one inorganic micro-filler material and the at least one thermally conductive filler material.

### DETAILED DESCRIPTION

The subject matter presented herein creates a platform technology for all silicone-based thermal interface materials that may or may not be using cheap industrial grade silicones, and specifically solves the contamination problem for GELVET® and related products. The present subject matter relates generally to a thermal interface material and more particularly to a polysiloxane coating characterized by low thermal resistance and free of oil contamination. A suitable thermal interface material or component should conform to the mating surfaces (“wets” the surface), possess a low bulk thermal resistance and possess a low contact resistance. Bulk thermal resistance can be expressed as a function of the material's or component's thickness, thermal conductivity and area. Contact resistance is a measure of how well a material or component is able to make contact with a mating surface, layer or substrate. The thermal resistance of an interface material or component can be shown as follows:
Θinterface=t/kA+2Θ_{contact} Equation 1
where
   Θ is the thermal resistance,
   t is the material thickness,
   k is the thermal conductivity of the material
   A is the area of the interface

The term “t/kA” represents the thermal resistance of the bulk material and “2Θ_{contact}” represents the thermal contact resistance at the two surfaces. A suitable interface material or component should have a low bulk resistance and a low contact resistance, i.e. at the mating surface.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components causes the gap to expand and contract with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material should be able to conform to non-planar surfaces, such as those found in GELVET® and similar components, and thereby lower contact resistance.

Optimal interface materials and/or components possess a high thermal conductivity and a high mechanical compliance, e.g. will yield elastically when force is applied. High thermal conductivity reduces the first term of Equation 1 while high mechanical compliance reduces the second term. The layered interface materials and the individual components of the layered interface materials described herein accomplish these goals. When properly oriented, the thermally conductive fibers of the compliant fibrous interface component described herein will span the distance between the mating surfaces thereby allowing a continuous high conductivity path from one surface to the other surface. If the fibers are flexible and able to move in its tip region, better contact can be made with the surface. This contact will result in an excellent degree of surface contact and will minimize the contact resistance of the interface material.

As mentioned, a coating material and/or composition has been developed that that a) has a low thermal resistance; b) is relatively free of oil contamination; c) makes a good coating composition; and d) can make a self-assembled physical barrier or interface between the underlying thermal interface material and additional components. Furthermore, the self-assembled physical barrier is formed inside the coating composition, utilizing a micro-filler and phase separation of two silicone based macro-monomers, which will subsequently be crosslinked to form a coating base. The composition generally comprises: a) at least two siloxane-based compounds with each compound having a different solubility parameter, such as a substituted polysiloxane and/or an alkenyl-terminated polydialkylsiloxane; b) at least one inorganic micro-filler material; and c) at least one thermally conductive filler material. Optionally, the coating composition and/or material may comprise additives including a catalyst, an inhibitor, and/or a rheological modifier. The materials and coating compositions disclosed herein creates a self-assembly physical barrier inside coating composition, utilizing a micro-filler and phase separation of different polysiloxanes. Low thermal resistance is achieved by using combined thermal fillers.

Additionally, a method of forming a thermal interface material is disclosed herein that includes: a) providing at least two siloxane-based compounds; b) providing at least one inorganic micro-filler material; c) providing at least one thermally conductive filler material; and d) combining the at least two siloxane-based compounds, the at least one inorganic micro-filler material and the at least one thermally conductive filler material.

As used herein, the term “interface” means a couple or bond that forms the common boundary between two parts of matter or space. An interface may comprise a physical attachment of two parts of matter or components or a physical attraction between two parts of matter or components, including bond forces such as covalent and ionic bonding, and non-bond forces such as Van der Waals, electrostatic, coulombic, hydrogen bonding and/or magnetic attraction.

The first contemplated component of the thermal interface materials and/or coating composition comprises at least one siloxane-based compound. Any suitable siloxane-based and/or polysiloxane compounds can be used, however, where there are more than two polysiloxane or siloxane-based compounds incorporated, each should have different solubility parameters. Also, it is contemplated that if there are two or more polysiloxane compounds present in the composition that they are incompatible and will inevitably form two separated organic micro-phases when mixed. In theory, the phase separation of the two macro-monomers cooperated with the filler forms a hedge membrane on the top surface of silicone coating and essentially blocks the passageway of the monomers and oligomers migrating from both coating and GELVAT® bases. The polysiloxane compound may be substituted by a functional group or other substituent. In contemplated embodiments, the substituents comprise the class of alkyl groups, aromatic groups, cage compounds and/or halide groups. As used herein, the term “alkyl” is used herein to mean a branched or unbranched saturated hydrocarbon group of at least one carbon atom, such as methyl, ethyl, n-propyl, isopropyl, n-butyl, isobutyl, t-butyl, octyl, decyl, tetradecyl, hexadecyl, eicosyl, tetracosyl and the like. Contemplated alkyl groups herein contain 1 to 100 carbon atoms, and more contemplated alkyl groups comprise 1 to 25 carbon atoms. As used herein, the term “aryl” or “aromatic” is used herein to mean a monocyclic aromatic species of 5 to 14 carbon atoms, and typically comprises a phenyl group. Optionally, these groups are substituted with one to four, more preferably one to two, lower alkyl, lower alkoxy, hydroxy, and/or nitro substituents. As used herein, the terms “halogen” and “halide” are used to mean fluoro, chloro, bromo, or iodo groups or substituents, and usually relates to halogen substitution for a hydrogen atom in an organic compound.

As used herein, the term “monomer” refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. Monomers may belong to various chemical classes of molecules including organic, organometallic or inorganic molecules. The molecular weight of monomers may vary greatly between about 40 Dalton and 20000 Dalton. However, especially when monomers comprise repetitive building blocks, then monomers may have even higher molecular weights. Monomers may also include additional groups, such as groups used for crosslinking.

As used herein, the term “crosslinking” refers to a process in which at least two molecules, or tow portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

As still further used herein, the phrases “cage structure”, “cage molecule”, and “cage compound” are intended to be used interchangeably and refer to a molecule having at least eight atoms arranged such that at least one bridge covalently connects two or more atoms of a ring system. In other words, a cage structure, cage molecule or cage compound comprises a plurality of rings formed by covalently bound atoms, wherein the structure, molecule or compound defines a volume, such that a point located within the volume cannot leave the volume without passing through the ring. The bridge and/or the ring system may comprise one or more heteroatoms, and may contain aromatic, partially saturated, or unsaturated groups. Further contemplated cage structures include fullerenes, and crown ethers having at least one bridge. For example, an adamantane or diamantane is considered a cage structure, while a naphthalene or an aromatic spirocompound are not considered a cage structure under the scope of this definition, because a naphthalene or an aromatic spirocompound do not have one, or more than one bridge.

The polysiloxane compound may also comprise at least one alkenyl-terminated polydialkylsiloxane. The term “alkenyl” is used herein to mean a branched or a straight-chain hydrocarbon chain containing from 2 to 24 carbon atoms and at least one double bond. Contemplated alkenyl groups herein contain 1 to 12 carbon atoms. In other contemplated embodiments, the alkenyl group of the alkenyl-terminated polydimethylsiloxane comprises 2 to 10 carbon atoms, and in other contemplated embodiments, the alkenyl group comprises a vinyl group. The alkyl substituent that forms part of the polydialkylsiloxane may comprise any suitable alkyl group already mentioned herein, and in contemplated embodiments, comprises a methyl group, an ethyl group, a propyl group, a butyl group or a pentyl group.

Another contemplated siloxane-based compound or material of contemplated thermal interface materials and/or coating compositions comprises at least one hydride-functional siloxane. As used herein, the term “hydride” means an inorganic compound of hydrogen with another element. Some hydrides are covalent and others are ionic. Hydrides may either be binary or complex; the latter are transition-metal complexes, e.g. carbonyl hydrides and cyclopentadienyl hydrides. Hawley's Condensed Chemical Dictionary, Fourteenth Edition, Richard J. Lewis, Sr., John Wiley & Sons, New York (2001). A contemplated hydride-functional siloxane comprises dimethylsiloxane-methylhydrosiloxane copolymer.

An additional contemplated component of thermal interface materials and/or coating compositions comprises at least one inorganic micro-filler or filler material. Contemplated inorganic filler materials may comprise silicon dioxide flakes or powder, silica powder or flakes or a combination thereof. Contemplated inorganic fillers comprise a chemical composition similar to that of silicon dioxide and is excessively blended into the coating composition. The filler is pre-coated with hexamethyldisilazane, which makes filler preferably compatible to only one type of polysiloxane. The flake-like filler also has a very small particle size (<0.1 micro) and a large surface area. Dispersion of filler particles can be facilitated by addition of functional organometallic coupling agents or “wetting” agents, such as organosilane, organotitanate, organozirconium, etc. Organotitanate acts a wetting enhancer to reduce paste viscosity and to increase filler loading. An organotitanate that can be used is isopropyl triisostearyl titanate. The general structure of organotitanate is RO-Ti(OXRY) where RO is a hydrolyzable group, and X and Y are binder functional groups.

Yet another contemplated component of contemplated thermal interface materials and/or coating compositions comprises at least one thermally conductive filler material. Thermal filler particles to be dispersed in the thermal interface component or mixture should advantageously have a high thermal conductivity. Suitable filler materials include metals, such as silver, copper, aluminum, and alloys thereof; and other compounds, such as boron nitride, aluminum nitride, silver coated copper, silver-coated aluminum, conductive polymers and carbon fibers. Combinations of boron nitride and silver or boron nitride and silver/copper also provide enhanced thermal conductivity. Boron nitride in amounts of at least 20 wt % and silver in amounts of at least about 60 wt % are particularly useful. Preferably, fillers with a thermal conductivity of greater than about 20 and most preferably at least about 40 w/m° C. can be used. Optimally, it is desired to have a filler of not less than about 80 w/m° C. thermal conductivity.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include indium, silver, copper, aluminum, tin, bismuth, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes.

Of special efficacy is a filler comprising a particular form of carbon fiber referred to as “vapor grown carbon fiber” (VGCF), such as is available from Applied Sciences, Inc., Cedarville, Ohio. VGCF, or “carbon micro fibers”, are highly graphized types by heat treatment (thermal conductivity=1900 w/m° C.). Addition of about 0.5 wt. % carbon micro fibers provides significantly increased thermal conductivity. Such fibers are available in varying lengths and diameters; namely, 1 millimeter (mm) to tens of centimeters (cm) length and from under 0.1 to over 100 μm in diameter. One useful form of VGCF has a diameter of not greater than about 1 μm and a length of about 50 to 100 μm, and possess a thermal conductivity of about two or three times greater than with other common carbon fibers having diameters greater than 5 μm.

It is difficult to incorporate large amounts of VGCF in polymer systems and interface components and systems, such as the hydrogenated rubber and resin combination already discussed. When carbon microfibers, e.g. (about 1 μm, or less) are added to the polymer they do not mix well, primarily because a large amount of fiber must be added to the polymer to obtain any significant beneficial improvement in thermal conductivity. However, we have discovered that relatively large amounts of carbon microfibers can be added to polymer systems that have relatively large amounts of other conventional fillers. A greater amount of carbon microfibers can be added to the polymer when added with other fibers, which can be added alone to the polymer, thus providing a greater benefit with respect to improving thermal conductivity of the thermal interface component. Desirably, the ratio of carbon microfibers to polymer is in the range of 0.05 to 0.50 by weight.

Optional materials may be added, such as catalysts, inhibitors and/or Theological modifiers. As used herein, the term “catalyst” means that substance or condition that notably affects the rate of a chemical reaction without itself being consumed or undergoing a chemical change. Catalysts may be inorganic, organic, or a combination of organic groups and metal halides. Although they are not substances, light and heat can also act as catalysts. In contemplated embodiments, the catalyst is an acid. In preferred embodiments, the catalyst is an organic acid, such as carboxylic, acetic, formic, benzoic, salicylic, dicarboxylic, oxalic, phthalic, sebacic, adipic, oleic, palmitic, stearic, phenylstearic, amino acids and sulfonic acid. Antioxidants may also be added to inhibit oxidation and thermal degradation of the cured rubber gel or solid thermal interface component. Typical useful antioxidants include Irganox 1076, a phenol type or Irganox 565, an amine type, (at 0.01% to about 1 wt. %), available from Ciba Giegy of Hawthorne, N.Y. Typical cure accelerators include tertiary amines such as didecylanethylamine, (at 50 ppm—0.5 wt. %).

One or more solvents may also be added to the thermal interface materials and/or coating compositions in order to modify the physical and/or chemical properties of the materials. Contemplated solvents include any suitable pure or mixture of organic or inorganic molecules that are volatilized at a desired temperature and/or easily solvates the thermal interface materials and/or coating compositions. The solvent may also comprise any suitable pure or mixture of polar and non-polar compounds. In some embodiments, the solvent comprises benzene, trichloroethylene, toluene, ethers, cyclohexanone, butryolactone, methylethylketone, and anisole. As used herein, the term “pure” means is composed of a single molecule or compound. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound.

In some contemplated embodiments, the solvent or solvent mixture (comprising at least two solvents) comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof.

In other contemplated embodiments, the solvent or solvent mixture may comprise those solvents that are not considered part of the hydrocarbon solvent family of compounds, such as ketones, such as acetone, diethyl ketone, methyl ethyl ketone and the like, alcohols, esters, ethers and amines. In yet other contemplated embodiments, the solvent or solvent mixture may comprise a combination of any of the solvents mentioned herein.

The coating material is designed to laminate any surface, substrate or surface area that comprises a thermal interface material or other suitable material that may contaminate additional layers with components and/or debris of the thermal interface material or composition. A contemplated thermal interface material comprises GELVET®.

GELVET®, as mentioned, is a compliant fibrous interface component that comprises a plurality of thermally conductive fibers, an encapsulant and an optional adhesive material. Examples of compliant fibrous interface components can be found in U.S. patent application Ser. No. 09/193,415; U.S. patent application Ser. No. 09/103,416 and U.S. patent application Ser. No. 09/333,564, and PCT Application Serial No. PCT/US02/17331 filed on May 30, 2002—all of which are commonly owned and incorporated herein by reference in their entirety. GELVET® comprises a thermal conductivity of about 30.0 W/mK, a thermal resistance of about 0.68° C.cm²/W (0.0010° C.cm²/W), is typically applied at a thickness of about 0.012 to 0.100 inches (0.3-2.5 mm) and comprises a typical softness of about greater than 25% of deflection under 10 psi. Typical characteristics of GELVET® are a) thickness variable over a wide range, b) compliance to geometric and thermal mismatch, c) very high thermal conductivity, and d) reliable over long-term use of the component.

Suitable thermally conductive fibers comprise diamond fibers, conductive polymer fibers, carbon fibers, graphite fibers and metal fibers, such as copper fibers and aluminum fibers. The thermally conductive fibers are cut to a particular length, e.g. from at least about 0.0005 inches to at least about 1 inch. Thermally conductive fibers contemplated herein may also be cut to at least about 0.001 inches, to at least about 0.01 inches and/or to at least about 0.1 inches. Thermally conductive fibers contemplated herein may have a fiber diameter of at least about 3 microns, of at least about 30 microns and/or at least about 300 microns. Conductive fibers having a fiber diameter of at least about 10 microns are presently preferred. Suitable thermally conductive fibers have a thermal conductivity of at least about 25 W/mK. Some suitable fibers are those available from Amoco identified as K-1100, K-800, P-120, P-100, P-70 and T50; as well as fibers available from Toray designated as M46J and M46JB.

Thermally conductive fibers disclosed herein can be cleaned, if necessary, to remove any coatings present on the fibers. Some commercially available fibers are sold with a coating applied to the surface, which is preferably removed by cleaning the fibers. One method of cleaning thermally conductive fibers is by heating the fibers in air to burn off the coating, i.e. sizing. However, chemical cleaning methods can also be used.

Substrates and surfaces contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polymimide. The “substrate” may even be defined as another polymer material when considering cohesive interfaces. In more preferred embodiments, the substrate comprises a material common in the packaging and circuit board industries such as silicon, copper, glass, and another polymer.

As mentioned, a method of forming a thermal interface material is disclosed herein that includes: a) providing at least two siloxane-based compounds; b) providing at least one inorganic micro-filler material; c) providing at least one thermally conductive filler material; and d) combining the at least two siloxane-based compounds, the at least one inorganic micro-filler material and the at least one thermally conductive filler material. It is contemplated that the steps of providing at least two siloxane-based compounds, at least one inorganic micro-filler material and at least one thermally conductive filler material can be achieved by a) buying these materials from a supplier; b) preparing or producing the these materials in house using chemicals provided by another source and/or c) preparing or producing these materials in house using chemicals also produced or provided in house or at the location.

In a contemplated embodiment, GELVET® is coated with a top coating so that any loose fiber debris can be mechanically blocked from the top surface, while simultaneously locking oil migration, without sacrificing thermal performance. The challenge of this approach comes from silicone base of GELVET®. As mentioned earlier, silicone has some intrinsic properties such as very low surface energy and a low coefficient of thermal expansion (CTE) compared with various polymers. These properties imply that the choice of coating material is limited to the one which has a similar silicone structure, otherwise delamination resulting from poor adhesion between silicone base and top coating and CTE mismatch will inevitably take place during burn-in process. However, silicone based coating cannot efficiently block oil migration from the thermal interface materials and itself in fact is a source of new oil contamination.

The thermally conductive coating composition can be applied on the thermal interface by an automatic screen printer and then heat cured. However, any suitable application process or method, such as ink jet printing, rolling, dripping, and spinning on, and any suitable curing method using extended or point sources, such as light sources, laser sources, and IR sources, may also be used. After applying the composition, the interface is installed onto the burn-in socket with the test chip. After five times high-speed actuation followed by 150° C. for 20 hours of high temperature baking, the test chip revealed a clean surface without any oil and fiber debris contamination.

Once the thermal interface materials and/or coating compositions are applied, additional layers or components may be added to the sealed material. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

A layer of laminating material or cladding material can be coupled to the layered interface materials depending on the specifications required by the component. Laminates are generally considered fiber-reinforced resin dielectric materials. Cladding materials are a subset of laminates that are produced when metals and other materials, such as copper, are incorporated into the laminates. (Harper, Charles A., Electronic Packaging and Interconnection Handbook, Second Edition, McGraw-Hill (New York), 1997.)

Spin-on layers and materials may also be added to the layered interface materials or subsequent layers. Spin-on stacked films are taught by Michael E. Thomas, “Spin-On Stacked Films for Low k_{eff} Dielectrics”, Solid State Technology (July 2001), incorporated herein in its entirety by reference.

Applications of the contemplated thermal interface components, layered interface materials and compliant fibrous interface components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

Generally, the concept and method of this invention is not limited to GELVET® material, but it is applicable on any silicone-based materials or those materials, which have any oil contamination concerns. So the thermal interface materials and/or coating compositions disclosed herein not only solved the problem of existing TIM products, but also creates a platform technology for future innovations. Furthermore, as discussed earlier, the thermal interface materials and/or coating compositions disclosed herein a) have a low thermal resistance; b) are relatively free of oil contamination; c) make good coating compositions; and d) make self-assembled physical barriers or interfaces between the underlying thermal interface material and additional components.

### EXAMPLES

In accordance with the present invention, the thermally conductive coating composition can be made and used as illustrated, by following preferred embodiments:

| | | | | | |
|---|---|---|---|---|---|
| Exp. 1 | Exp. 2 | Exp. 3 | Exp. 4 | Exp. 5 | Exp. 6 |

PART A

| | | | | | | |
|---|---|---|---|---|---|---|
| Vinyl terminated | 30-50% | 30-50% | 30-50% | 30-50% | 30-50% | 30-50% |
| polydimethylsiloxane | | | | | | |
| Platinum catalyst solution | 0.05-0.5% | 0.05-0.5% | 0.05-0.5% | 0.05-0.5% | 0.05-0.5% | 0.05-0.5% |
| silicon dioxide flake | 5-20% | 5-20% | 5-20% | 5-20% | 5-20% | 5-20% |
| Boron Nitride | 10-50% | 5-20% | | 10-50% | 10-50% | 10-50% |
| Copper powder | | 10-50% | | | | |
| Silica powder | | | 25-60% | | | |
| Eeonomer(conductive polymer | 0.1-0.5% | 0.1-0.5% | 0.1-0.5% | 0.1-0.5% | 0.1-0.5% | 0.1-0.5% |
| filler) | | | | | | |

PART B

| | | | | | | |
|---|---|---|---|---|---|---|
| Vinyl terminated | 60-90% | 60-90% | 60-90% | | | |
| polydimethylsiloxane | | | | | | |
| Dimethylsiloxane- | 5-20% | 5-20% | 5-20% | | | |
| methylhydrosiloxane | | | | | | |
| copolymer | | | | | | |
| Vinylmethylcyclotetrasiloxane | 0.1-1% | 0.1-1% | 0.1-1% | | | |
| Polytetradecylmethylsiloxane | 1-10% | 1-10% | 1-10% | | | |
| Polyoctylmethylsiloxane | | | | 1-10% | | |
| Decylmethylsiloxane/butylated | | | | | 1-10% | |
| aryloxy-propylmethylsiloxane | | | | | | |
| Octadecylmethylsiloxane/ | | | | | | 1-10% |
| dimethylsiloxane | | | | | | |

The components of Part A were weighted and mixed in a Hobart mixer for about 10 min. to form a dough and then further processed by a three-roll mixer for three passes and degassed in a planetary mixer under the full vacuum (≦−98 Kpa) for about 20 min. The components of Part B were weighted and mixed in a planetary mixer under the full vacuum (≦−98 Kpa) for about 20 min. The components can then be stored at room temperature until blending before use. The coating composition is obtained by blending Part A with Part B in a ratio of 4:1 by weight in a planetary mixer under the full vacuum (<−98 Kpa) for about 10 min. The composition is then stored in a −40C freezer.

At this point it should be understood that, unless otherwise indicated, all numbers expressing quantities of ingredients, constituents, reaction conditions and so forth used in the specification and claims are to be understood as being modified in all instances by the term “about”. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

The coating composition is applied on to the GELVET® surface by an automatic screen printer or appropriate methods. The composition is first thawed at room temperature for about 15 min after removing from the freezer and laminated on the top surface of the TIM using 1.7 mil-opening screen, then vacuumed for seven minutes. The coated GELVET® is then cured in a 150° C. box oven for about 60 min. For the other silicone based thermal interface materials, the said coating composition can be stencil (thickness less than 0.5 mil) printed on the top surface, vacuumed and then oven cured for about 60 min at 150° C.

Thus, specific embodiments and applications of thermally conductive coating compositions have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A thermal interface composition, comprising:
at least two siloxane-based compounds, wherein each compound has a different solubility parameter,
at least one inorganic micro-filler material, and
at least one thermally conductive filler material.

2. The thermal interface composition of claim 1, wherein at least one of the siloxane-based compounds comprises a polysiloxane compound.

3. The thermal interface composition of claim 1, wherein at least one of the siloxane-based compounds comprises a hydride-functional siloxane compound.

4. The thermal interface composition of claim 2, wherein the polysiloxane compound comprises a substituted polysiloxane compound.

5. The thermal interface composition of claim 4, wherein the polysiloxane compound is substituted by a functional group comprising an alkyl group, an aromatic group, a halide group or a combination thereof.

6. The thermal interface composition of claim 4, wherein the substituted polysiloxane compound comprises an alkenyl-terminated polyalkylsiloxane.

7. The thermal interface composition of claim 6, wherein the alkenyl-terminated polyalkylsiloxane comprises a vinyl group.

8. The thermal interface composition of claim 7, wherein the alkenyl-terminated polyalkylsiloxane further comprises a methyl group.

9. The thermal interface composition of claim 5, wherein the polysiloxane compound comprises vinylmethylcyclotetrasiloxane, polytetradecylmethylsiloxane, polyoctylmethylsiloxane, decylmethylsiloxane, butylated aryloxy-propylmethylsiloxane, ctadecylmethylsiloxane, dimethylsiloxane or a combination thereof.

10. The thermal interface composition of claim 3, wherein the hydride-functional siloxane comprises methylhydrosiloxane.

11. The thermal interface composition of claim 1, wherein the inorganic micro-filler material comprises silicon dioxide.

12. The thermal interface composition of claim 1, wherein the inorganic micro-filler material comprises a powder.

13. The thermal interface composition of claim 1, wherein the inorganic micro-filler material comprises a flake.

14. The thermal interface composition of claim 1, wherein the thermally conductive filler material comprises a transition metal.

15. The thermal interface composition of claim 1, wherein the thermally conductive filler material comprises boron.

16. The thermal interface composition of claim 14, wherein the transition metal comprises copper.

17. The thermal interface composition of claim 15, wherein the thermally conductive filler material comprises boron nitride.

18. The thermal interface material of claim 1, further comprising at least one additive.

19. The thermal interface material of claim 18, wherein the additive comprises a catalyst.

20. The thermal interface material of claim 18, wherein the additive comprises an inhibitor.

21. The thermal interface material of claim 18, wherein the additive comprises a rheological modifier.

22. The thermal interface composition of claim 19, wherein the catalyst comprises platinum.

23. The thermal interface composition of claim 20, wherein the inhibitor comprises an antioxidant.

24. The thermal interface composition of claim 21, wherein the Theological modifier comprises at least one solvent.

25. A coating composition comprising the thermal interface composition of claim 1.

26. A coating composition comprising the thermal interface composition of claim 18.

27. An electronic component comprising the thermal interface composition of claim 1.

28. An electronic component comprising the thermal interface composition of claim 18.

29. An electronic component comprising the coating solution of claim 25.

30. An electronic component comprising the coating solution of claim 26.

31. A semiconductor component comprising the thermal interface composition of claim 1.

32. A semiconductor component comprising the thermal interface composition of claim 18.

33. A semiconductor component comprising the coating solution of claim 25.

34. A semiconductor component comprising the coating solution of claim 26.

35. A method of forming a thermal interface material, comprising:
providing at least two siloxane-based compounds, wherein each compound has a different solubility parameter,
providing at least one inorganic micro-filler material,
providing at least one thermally conductive filler material, and
combining the at least two siloxane-based compounds, the at least one inorganic micro-filler material and the at least one thermally conductive filler material.

36. The method of claim 35, wherein at least one of the siloxane-based compounds comprises a polysiloxane compound.

37. The method of claim 35, wherein at least one of the siloxane-based compounds comprises a hydride-functional siloxane compound.

38. The method of claim 36, wherein the polysiloxane compound comprises a substituted polysiloxane compound.

39. The method of claim 38, wherein the polysiloxane compound is substituted by a functional group comprising an alkyl group, an aromatic group, a halide group or a combination thereof.

40. The method of claim 38, wherein the substituted polysiloxane compound comprises an alkenyl-terminated polyalkylsiloxane.

41. The method of claim 40, wherein the alkenyl-terminated polyalkylsiloxane comprises a vinyl group.

42. The method of claim 41, wherein the alkenyl-terminated polyalkylsiloxane further comprises a methyl group.

43. The method of claim 39, wherein the polysiloxane compound comprises vinylmethylcyclotetrasiloxane, polytetradecylmethylsiloxane, polyoctylmethylsiloxane, decylmethylsiloxane, butylated aryloxy-propylmethylsiloxane, octadecylmethylsiloxane, dimethylsiloxane or a combination thereof.

44. The method of claim 37, wherein the hydride-functional siloxane comprises methylhydrosiloxane.

45. The method of claim 35, wherein the inorganic micro-filler material comprises silicon dioxide.

46. The method of claim 35, wherein the inorganic micro-filler material comprises a powder.

47. The method of claim 35, wherein the inorganic micro-filler material comprises a flake.

48. The method of claim 35, wherein the thermally conductive filler material comprises a transition metal.

49. The method of claim 35, wherein the thermally conductive filler material comprises boron.

50. The method of claim 48, wherein the transition metal comprises copper.

51. The method of claim 49, wherein the thermally conductive filler material comprises boron nitride.

52. The method of claim 35, further comprising at least one additive.

53. The method of claim 52, wherein the additive comprises a catalyst.

54. The method of claim 52, wherein the additive comprises an inhibitor.

55. The method of claim 52, wherein the additive comprises a rheological modifier.

56. The method of claim 53, wherein the catalyst comprises platinum.

57. The method of claim 54, wherein the inhibitor comprises an antioxidant.

58. The method of claim 55, wherein the rheological modifier comprises at least one solvent.

59. A coating composition produced from the method of claim 35.

60. A coating composition produced from the method of claim 52.

61. An electronic component comprising the coating solution of claim 59.

62. An electronic component comprising the coating solution of claim 60.

63. A semiconductor component comprising the coating solution of claim 59.

64. A semiconductor component comprising the coating solution of claim 60.
